(19) United States
(12) Patent Application Publication
(10) Pub. No.: US 2019/0301618 A1
(43) Pub. Date: Oct. 3, 2019

(54) VALVE ASSEMBLY

(71) Applicant: CHI-PIN SHIH, CHANGHUA COUNTY (TW)

(72) Inventor: CHI-PIN SHIH, CHANGHUA COUNTY (TW)

(21) Appl. No.: 15/936,667

(22) Filed: Mar. 27, 2018

(51) Int. Cl. F16K 11/074; F16K 31/524; F16K 27/04

(52) U.S. Cl. CPC F16K 11/074; F16K 31/602; F16K 27/045; F16K 31/52425

(57) ABSTRACT

A valve assembly includes a connection portion and an outlet portion. The connection portion is adapted to be connected with a water dispenser or a pipe. A passage is defined axially through the connection portion and the outlet portion, and a transverse hole is defined transversely through the outlet portion and communicates with the passage. A control member is movably inserted in the transverse hole and includes at least one neck and a seal section. The seal section has a seal tube mounted thereto. When the control member moves in the transverse hole, and the neck is moved to be located corresponding to the passage, the passage is opened and water may flows through the passage. When the seal section is moved to be located corresponding to the passage, the passage is sealed.

### BACKGROUND OF THE INVENTION

### 1. Fields of the invention

The present invention relates to a valve assembly, and more particularly, to a valve assembly for being used in water dispensers, faucets or the like.

### 2. Descriptions of Related Art

The conventional valve assembly for faucets generally includes a ball valve with a lever extending therefrom, and the uses operate the lever to rotate the ball valve to communicate the passage of the ball valve and the pipe of the water source to get water from the faucet. However, the conventional valve assembly has a fixed outer appearance which may not be satisfied by the users. The conventional valve assembly protrudes beyond the wall and occupies a certain space. The protruded valve assembly may also be a safety issue. Most of the conventional valve assemblies comprise multiple small parts that increase the manufacturing cost. The lever is made of plastic which is easily broken by impact. For water dispensers, there are two outlet pipes required and each outlet pipe is connected with a conventional valve assembly. The two outlet pipes and two valve assembles occupy a lot of space, and the conventional valve assemblies have the same problems mentioned above.

The present invention intends to provide a valve assembly which is compact and designed to eliminate the shortcomings mentioned above.

### SUMMARY OF THE INVENTION

The present invention relates to a valve assembly and comprises a connection portion and an outlet portion. The connection portion is adapted to be connected with a water dispenser or a pipe. A passage is defined axially through the connection portion and the outlet portion. A transverse hole is defined transversely through the outlet portion and communicates with the passage. A control member is movably inserted in the transverse hole and includes at least one neck and a seal section. The seal section has a seal tube mounted thereto. When the control member moves in the transverse hole, and the neck is moved to be located corresponding to the passage, the passage is opened and water may flows through the passage. When the seal section is moved to be located corresponding to the passage, the passage is sealed.

The primary object of the present invention is to provide a valve assembly that is compact and does not have the lever as seen on the conventional valve assemblies. The operation is easy and simple by moving the control member back and forth.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the valve assembly of the present invention;

FIG. 2 is an exploded view to show the valve assembly of the present invention;

FIG. 3 is a cross sectional view, taken along line III-III of FIG. 3;

FIG. 4 is a cross sectional view to show that the neck is located corresponding to the passage;

FIG. 5 is a perspective view to show that the valve assembly of the present invention is used in a water dispenser;

FIG. 6 is a cross sectional view, taken along line VI-VI of FIG. 5;

FIG. 7 is a perspective view to show that the valve assembly of the present invention is used with a water pipe;

FIG. 8 is a perspective view to show that the valve assembly of the present invention is an L-shaped valve;

FIG. 9 shows that the valve assembly of the present invention is connected on a wall;

FIG. 10 is an exploded view to show another embodiment of the control member of the valve assembly of the present invention;

FIGS. 11 to 13 show that the control member is moved to different positions in the transverse hole of the valve assembly of the present invention;

FIG. 14 shows another embodiment of the connection portion of the valve assembly of the present invention, and

FIG. 15 is a cross sectional view, taken along line XV-XV of FIG. 14.

### DETAILED DESCRIPTION OF THE PREFERRED EMBODIMENT

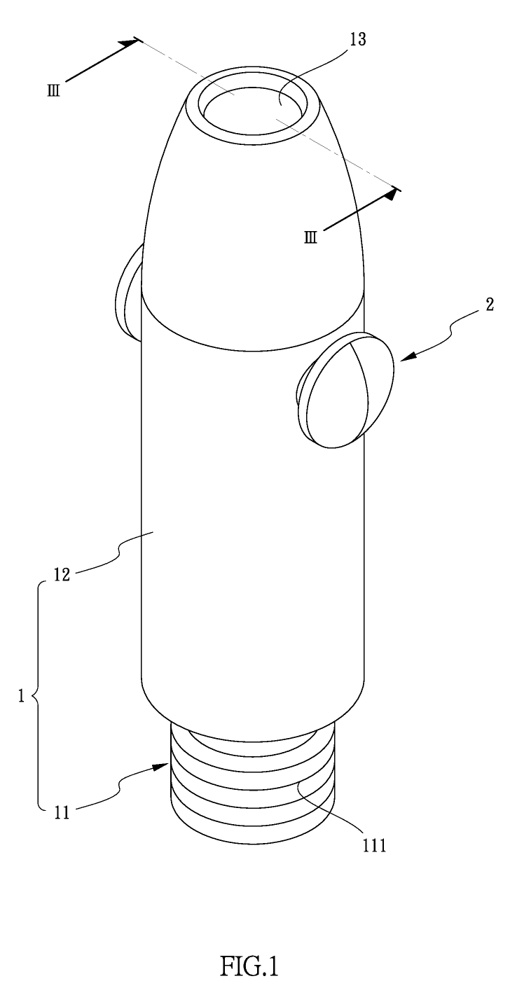

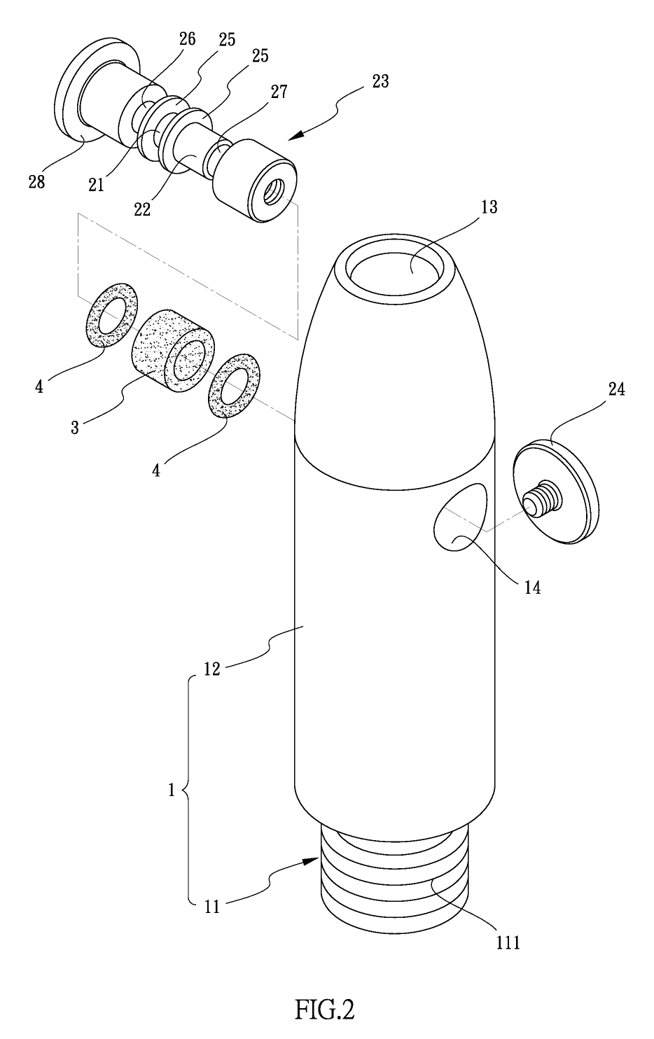

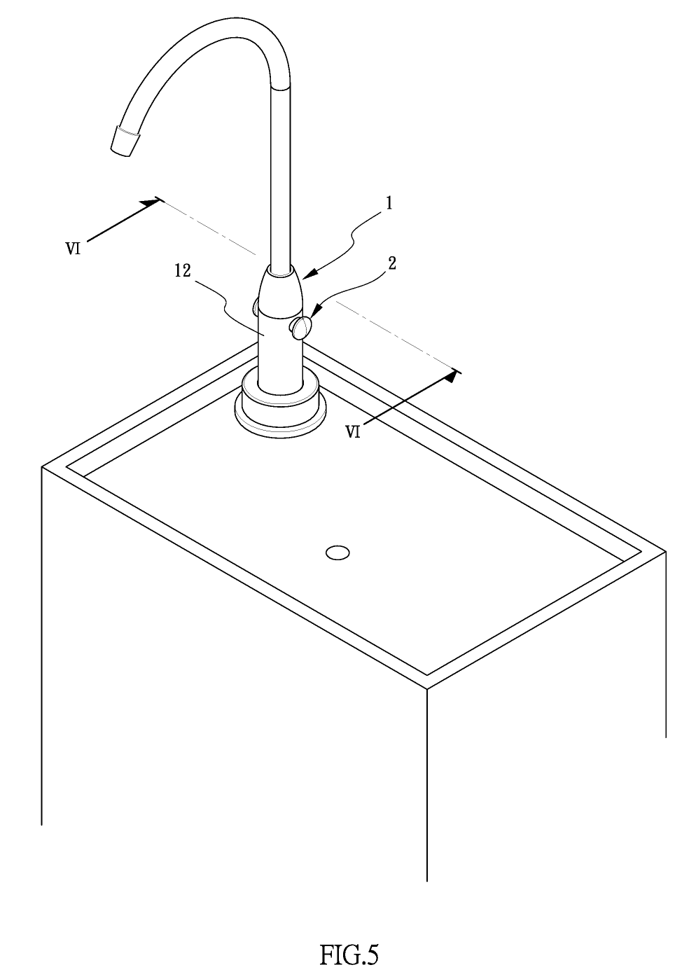

Referring to FIGS. 1 to 6, the valve assembly 1 of the present invention is to be connected to a water dispenser or a water pipe, and comprises a connection portion 11 and an outlet portion 12 which is connected to the connection portion 11. The connection portion 11 protrudes from one end of the outlet portion 12 and includes outer threads 111 which are used to be connected to a water dispenser or a water pipe as desired. The outlet portion 12 is a bullet-shaped portion. A passage 13 is defined axially through the connection portion 11 and the outlet portion 12. A transverse hole 14 is defined transversely through the outlet portion 12 and communicating with the passage 13. The connection portion 11 is to be connected with a water dispenser or a water pipe so that water may flow through the passage 13. A control member 2 is an elongate member and movably inserted in the transverse hole 14. The control member 2 includes at least one neck 21 and a seal section 22, wherein the diameter of the at least one neck 21 is smaller than that of the control member 2. The seal section 22 has a seal tube 3 mounted thereto.

Specifically, the control member 2 comprises an elongate body 23 and a locking member 24, the body 23 has the at least one neck 21 and the seal section 22 formed thereto. Two flanges 25 are respectively located on two ends of the at least one neck 21, and the two flanges 25 respectively contact the first end of the seal section 22 and a first reduced section 26. The second end of the seal section 22 is axially connected with a second reduced section 27. Each of the first and second reduced sections 26, 27 has a seal ring 4 mounted thereto. The seal rings 4 contact the inner periphery of the transverse hole 14. A head 28 is formed on the first end of the body 23, and the locking member 24 is connected to the second end of the body 23. The head 28 and the locking member 24 are larger than the transverse hole 14 so that the control member 2 does not drop off from the transverse hole 14.

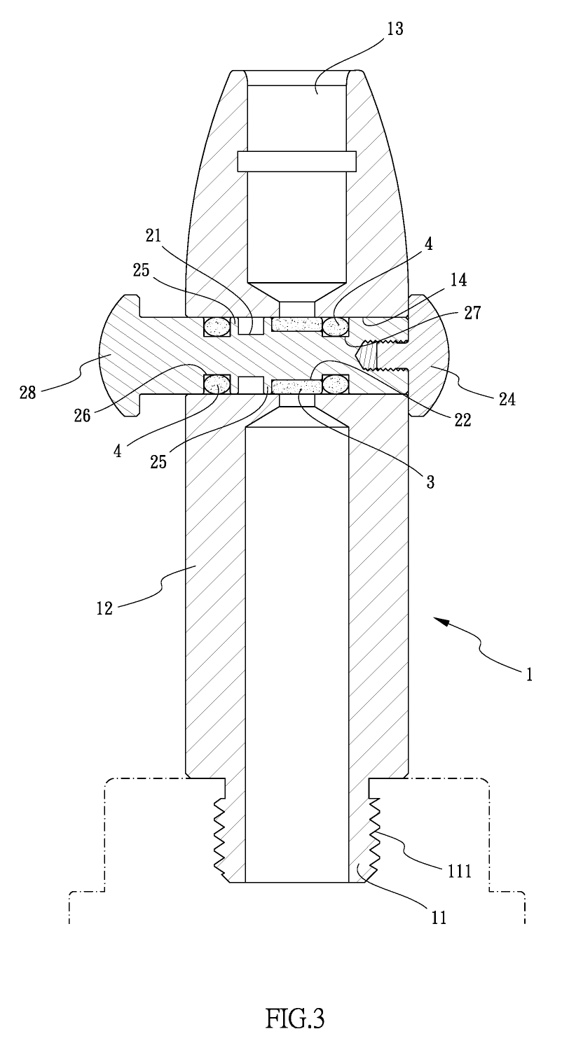

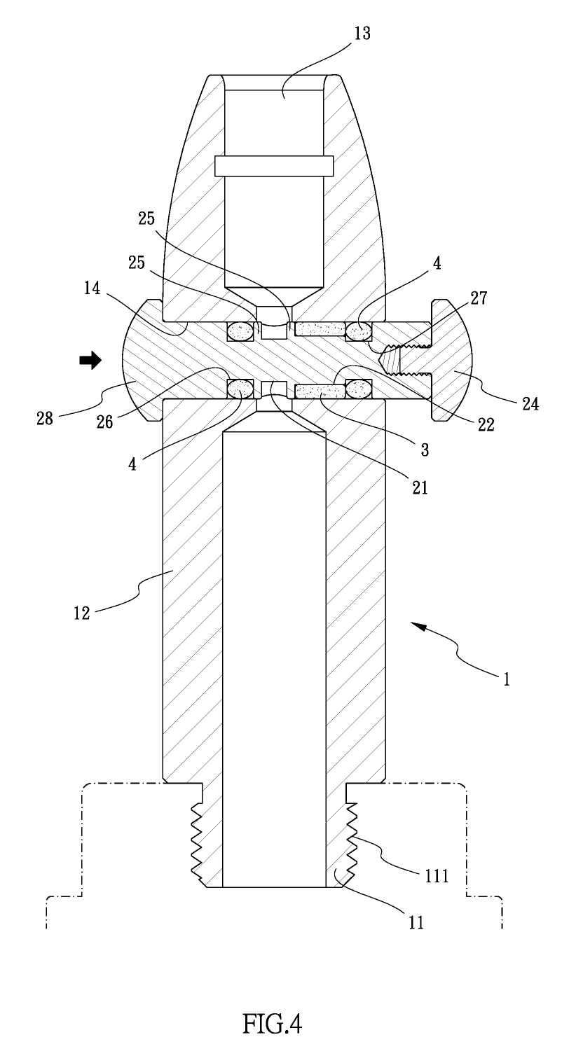

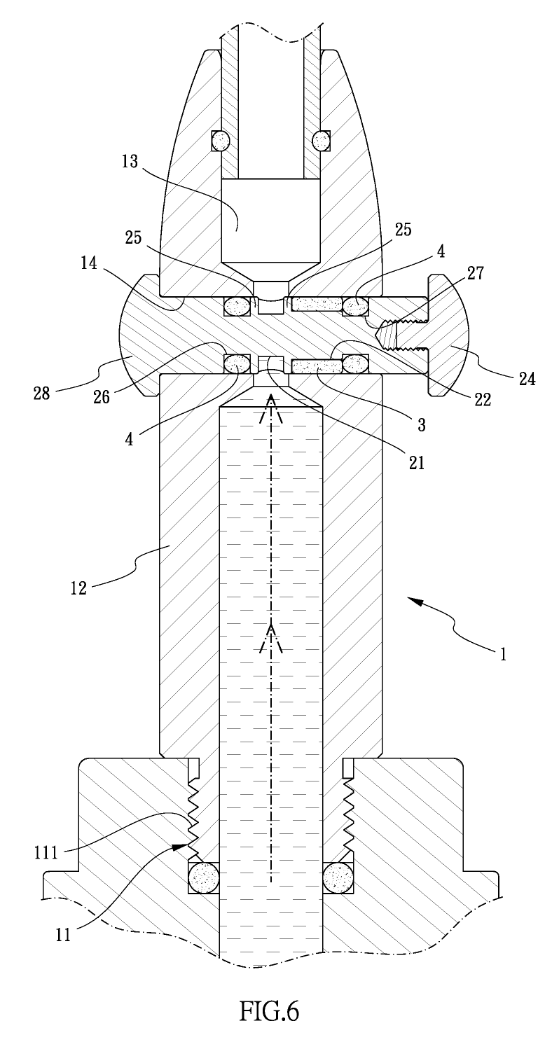

When the control member 2 moves in the transverse hole 14, and the neck 21 is moved to be located corresponding to the passage 13, because the diameter of the neck 21 is smaller than the body 23, so that the passage 13 is opened and water is able to flow through the passage 13 and the users get the water from the outlet portion 12 as shown in FIGS. 4 and 6. When the seal section 22 is moved to be located corresponding to the passage 13, because the seal tube 3 seals the transverse hole 14 and the passage 13, so that the passage 13 is sealed and the water does not flow out from the outlet portion 12 as shown in FIG. 3. The seal rings 4 prevent leakage between the inner periphery of the transverse hole 14 and the control member 2.

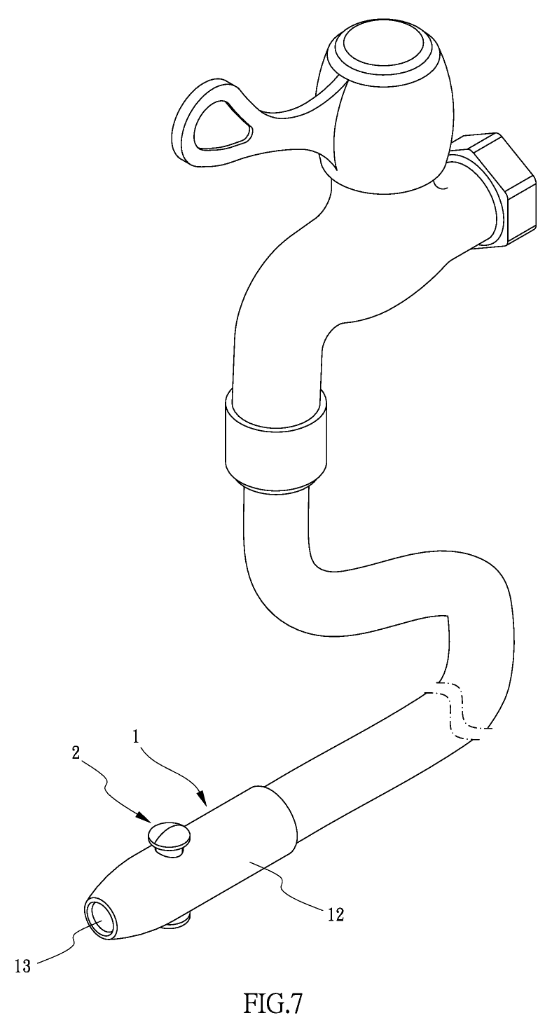

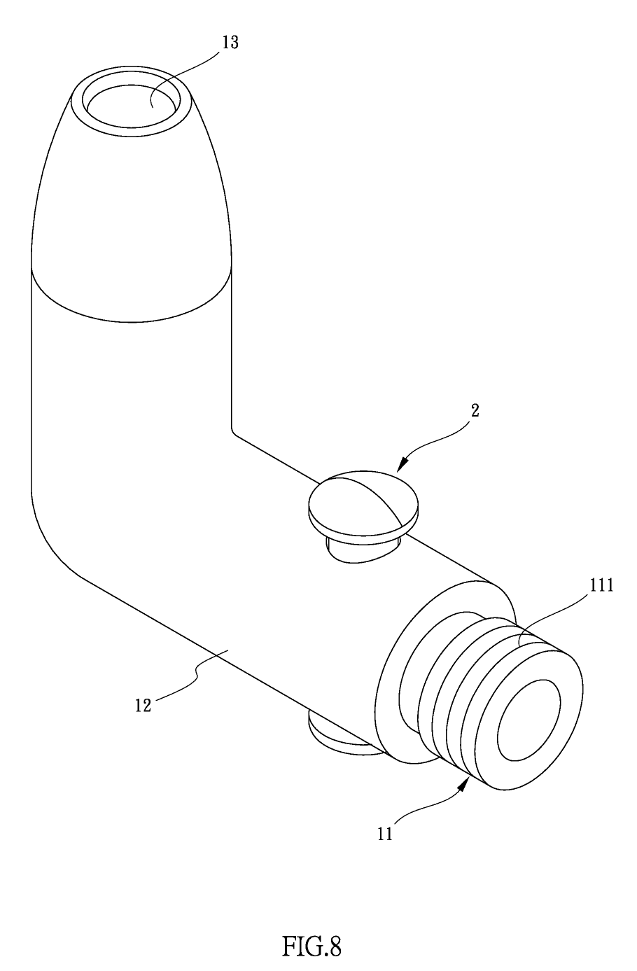

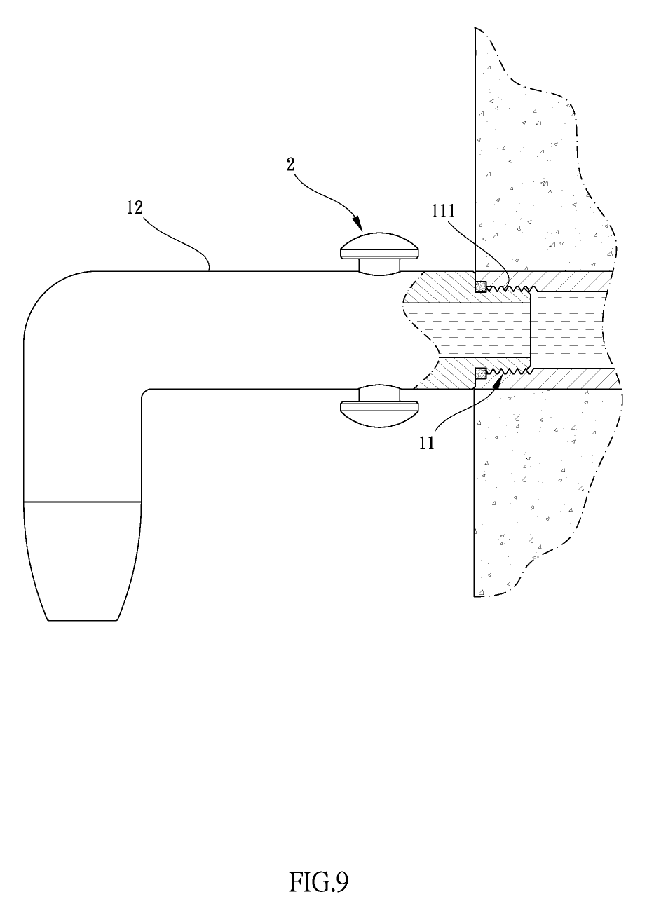

FIG. 7 shows that the valve assembly 1 of the present invention is directly connected with a water pipe which is connected with a conventional faucet. The user can keep the conventional lever at open position, and controls the water flow by operating the valve assembly 1 of the present invention. FIGS. 8 and 9 show that the valve assembly 1 of the present invention is an L-shaped valve, specifically, the outlet portion 12 is an L-shaped portion. The valve assembly 1 is connected to a wall.

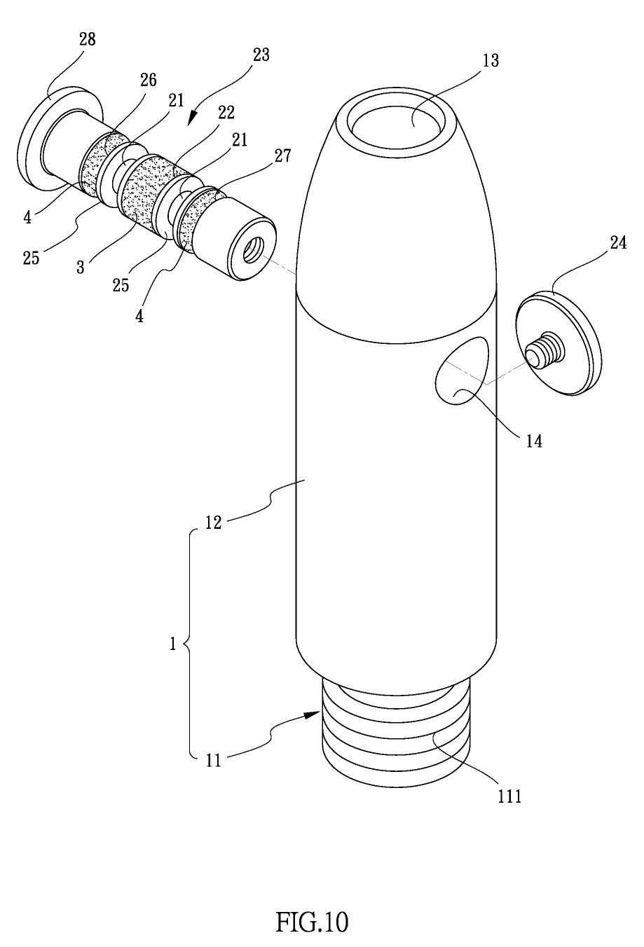

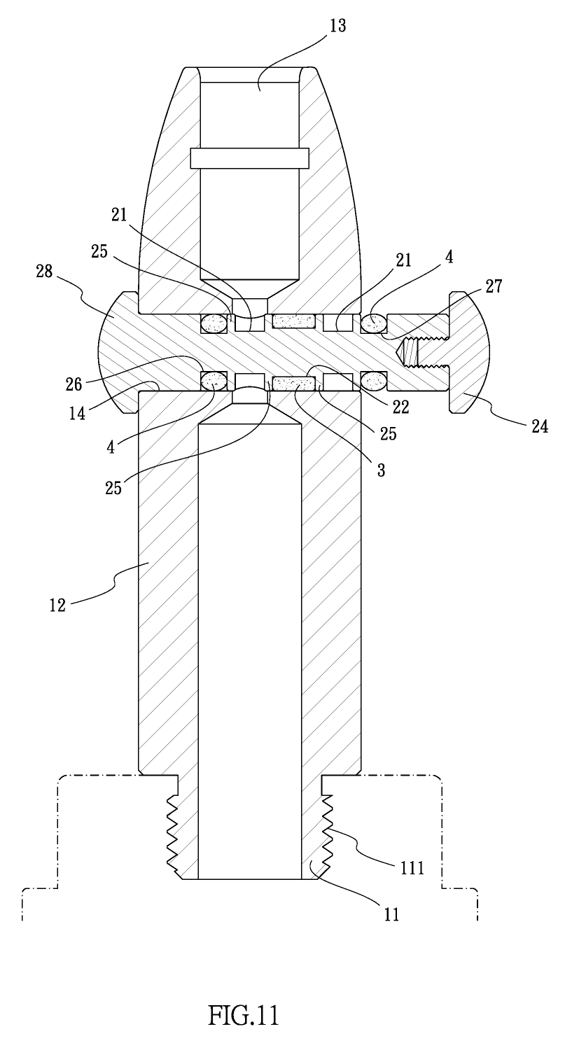

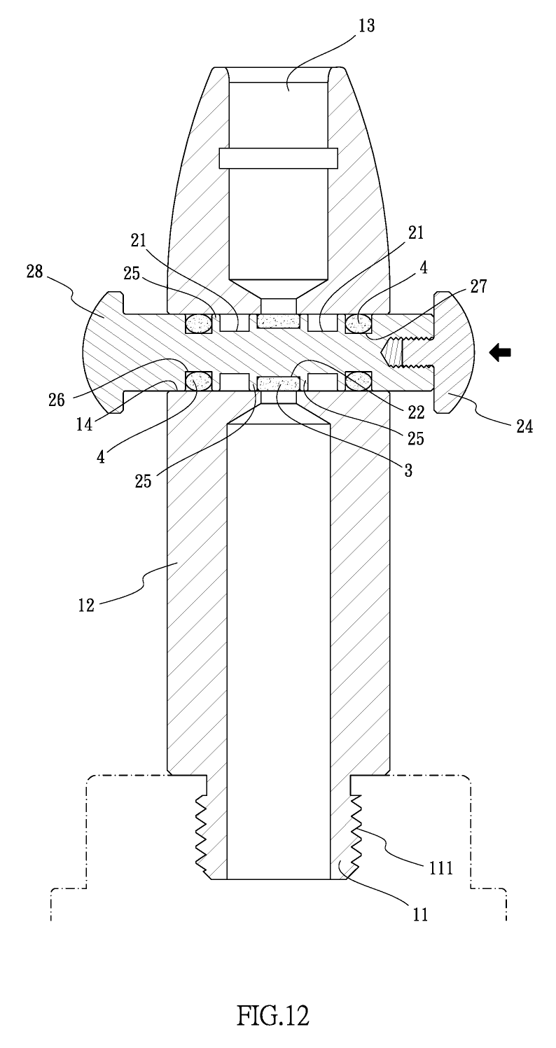

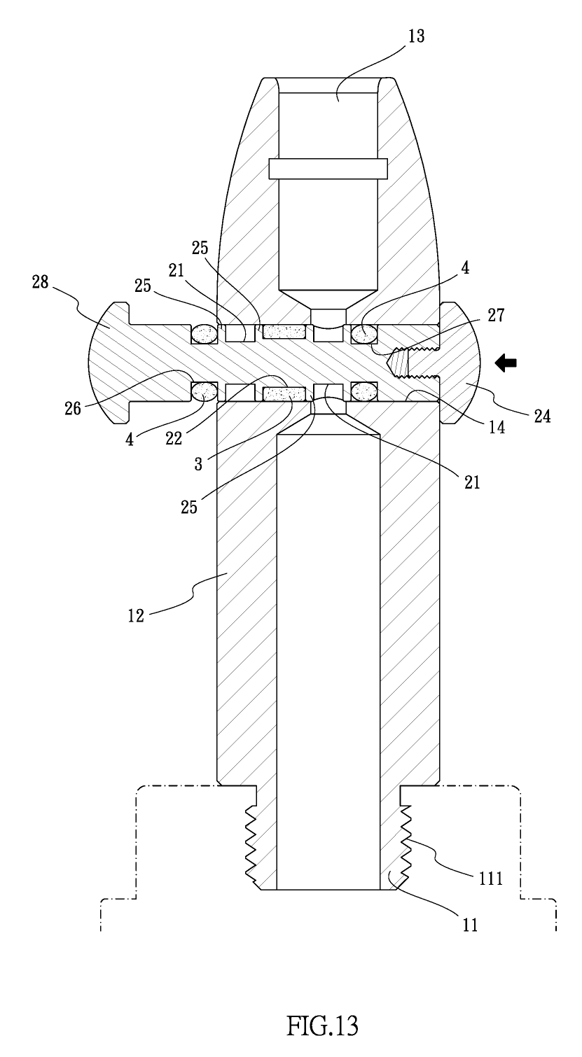

FIGS. 10 to 13 show another embodiment of the control member 2, wherein the control member 2 comprises a body 23 and a locking member 24. The body 23 has two necks 21, and the seal section 22 is located between the two necks 21. Two flanges 25 are respectively located on two ends of the seal section 22, and the two flanges 25 respectively contact the two necks 21. A first reduced section 26 and a second reduced section 27 are respectively connected with the two necks 21. Each of the first and second reduced sections 26, 27 has a seal ring 4 mounted thereto. The seal rings 4 contact the inner periphery of the transverse hole 14. The seal tube 3 is mounted to the seal section 22. A head 28 is formed on the first end of the body 23, and the locking member 24 is connected to the second end of the body 23 and located close to the first reduced section 26 or the second reduced section 27. In this embodiment, the locking member 24 is located close to the second reduced section 27. In this embodiment, the users can operate the control member 2 in two opposite directions to get the water.

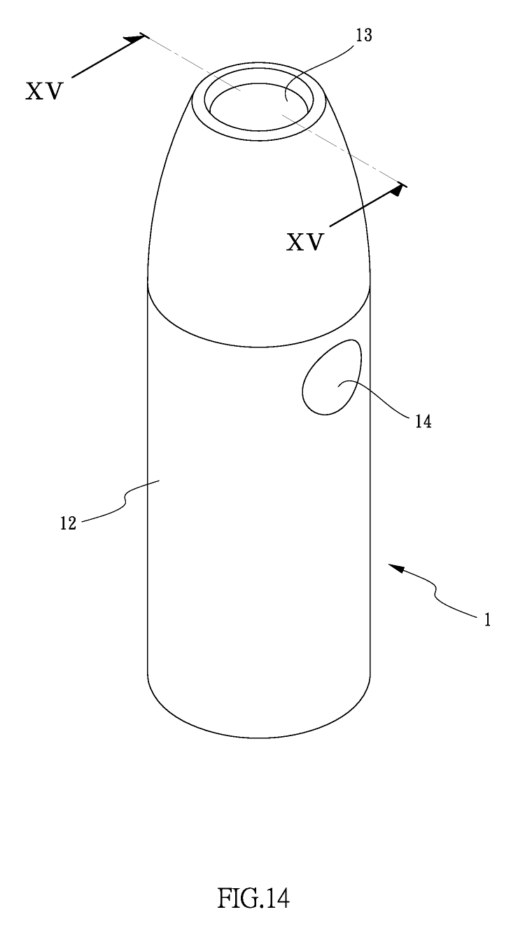

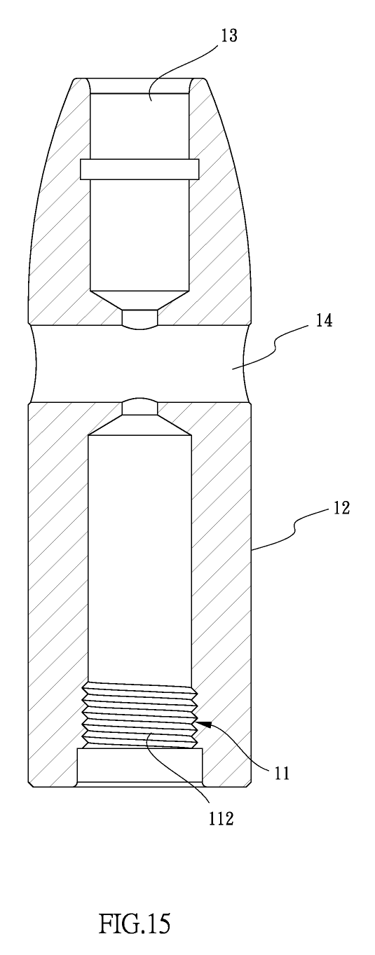

FIGS. 14 and 15 show that the connection portion 11 is defined in one end of the outlet portion 12 and includes inner threads 112 which are used to be connected to the water dispenser or the water pipe with a protruded threaded section.

While we have shown and described the embodiment in accordance with the present invention, it should be clear to those skilled in the art that further embodiments may be made without departing from the scope of the present invention.

What is claimed is:

1. A valve assembly comprising:
a connection portion and an outlet portion which is connected to the connection portion, a passage defined axially through the connection portion and the outlet portion, a transverse hole defined transversely through the outlet portion and communicating with the passage, and
a control member movably inserted in the transverse hole and having at least one neck and a seal section, the seal section having a seal tube mounted thereto, when the control member moves in the transverse hole, and the neck is moved to be located corresponding to the passage, the passage is opened, when the seal section is moved to be located corresponding to the passage, the passage is sealed.

2. The valve assembly as claimed in claim 1, wherein the control member comprises a body and a locking member, the body has the at least one neck and the seal section formed thereto, two flanges are respectively located on two ends of the at least one neck, the two flanges respectively contact a first end of the seal section and a first reduced section, a second end of the seal section is axially connected with a second reduced section, each of the first and second reduced sections has a seal ring mounted thereto, the seal rings contact an inner periphery of the transverse hole, a head is formed on a first end of the body, the locking member is connected to a second end of the body.

3. The valve assembly as claimed in claim 1, wherein the control member comprises a body and a locking member, the body has two necks, the seal section is located between the two necks, two flanges are respectively located on two ends of the seal section, the two flanges respectively contact the two necks, a first reduced section and a second reduced section respectively connected with the two necks, each of the first and second reduced sections has a seal ring mounted thereto, the seal rings contact an inner periphery of the transverse hole, the seal tube is mounted to the seal section, a head is formed on a first end of the body, the locking member is connected to a second end of the body and located close to the first reduced section or the second reduced section.

4. The valve assembly as claimed in claim 1, wherein the connection portion protrudes from one end of the outlet portion and includes outer threads.

5. The valve assembly as claimed in claim 1, wherein the connection portion is defined in one end of the outlet portion and includes inner threads.

6. The valve assembly as claimed in claim 4, wherein the outlet portion is a bullet-shaped portion or an L-shaped portion.
